(19) United States
(12) Patent Application Publication
(10) Pub. No.: US 2014/0279784 A1
(43) Pub. Date: Sep. 18, 2014

(54) PARTIAL PREDICTIVE MODELING

(71) Applicant: KXEN, INC., San Francisco, CA (US)

(72) Inventors: Marco S. Casalaina, San Francisco, CA (US); Bruno Delahaye, San Francisco, CA (US)

(21) Appl. No.: 13/828,891

(22) Filed: Mar. 14, 2013

(51) Int. Cl. G06N 5/02

(52) U.S. Cl. CPC G06N 5/02
USPC 706/46

(57) ABSTRACT

A computerized method disclosed herein for analyzing data based on multiple disparate datasets generates a unified predictive model based on a unified dataset, wherein the unified dataset includes data from the multiple disparate datasets. The unified predictive model is partitioned into a number of partial predictive models. A number partial predictions are generated by applying each of the partial predictive models to data from each of the plurality of datasets and the plurality of partial predictions are combined to generate a unified prediction.

### FIELD

Implementations disclosed herein relate, in general, to information management technology and specifically to technology for analyzing information.

### BACKGROUND

Accurate prediction relies heavily upon the ability to analyze a large amount of data. This task is difficult because of the sheer quantity of data involved and the complexity of the analyses that must be performed. The problem is exacerbated by the fact that the data often resides in multiple databases, each database having different structures. For example, organizations often spread data across multiple databases, with some of these databases being transactional databases and others being various types of analytical data warehouses, cloud-based databases, on-premise databases, etc. Due to the differences among these databases in terms of their structures, locations, access restrictions, etc., it is difficult to analyze the data in efficient manner.

### SUMMARY

A computerized method disclosed herein for analyzing data based on multiple disparate datasets generates a unified predictive model based on a unified dataset, wherein the unified dataset includes data from the multiple disparate datasets. The unified predictive model is partitioned into a number of partial predictive models. A number of partial predictions are generated by applying each of the partial predictive models to data from each of the plurality of datasets and the plurality of partial predictions are combined to generate a unified prediction.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various embodiments and implementations as further illustrated in the accompanying drawings and defined in the appended claims.

### BRIEF DESCRIPTION OF THE DRAWINGS

A further understanding of the nature and advantages of the present technology may be realized by reference to the figures, which are described in the remaining portion of the specification.

FIG. 1 illustrates an example block diagram of a data analysis system disclosed herein.

FIG. 2 illustrates an example block diagram representing various modules of the data analysis system disclosed herein.

FIG. 3 illustrates an alternative example block diagram representing various modules of the data analysis system disclosed herein.

FIG. 4 illustrates an example of a graph illustrating breakdown of various variables according to the data analysis system disclosed herein.

FIG. 5 illustrates an alternative example block diagram representing various modules of the data analysis system disclosed herein.

FIG. 6 illustrates another alternative example block diagram representing various modules of the data analysis system disclosed herein

FIG. 7 illustrates an example flowchart for using the data analysis system disclosed herein.

FIG. 8 illustrates an alternative example flowchart for using the data analysis system disclosed herein.

FIG. 9 illustrates an example computing system that can be used to implement the data analysis system disclosed herein.

### DETAILED DESCRIPTION

In modern economies, most organizations generate, use and deal with a large amount of data. Organizations may use the data to their advantage by analyzing the data to make predictions that help them further their organizational goals. One of the many techniques used by the organizations to analyze data is predictive modeling. Predictive modeling is a process by which a model is created or chosen to try to predict the probability of an outcome or to estimate an unknown quantity. An organization may use predictive modeling to analyze data and generate prediction outcomes. Thus, organizations can use predictive modeling to make predictions about clients, markets, events, economy, etc. For instance, a savings institution, such as a bank, might employ a predictive modeling technique using the client data in its possession to predict which of its customers might be in the position to use one or more of its retirement savings products.

However, organizations typically employ many different data storage methods and locations to meet their data storage needs. Data is often spread across more than one transactional database, analytical data warehouse, cloud-based database, on-premise database, etc. As a result, it can become difficult for organizations to deploy their predictive models on the diverse and widely dispersed datasets. Predictive modeling generally has two phases: a “learn” phase, wherein the predictive modeling system determines the patterns that correspond to the event in question, and a “score” phase, wherein the predictive modeling system creates scores, or numerical predictions, of the event in question.

Data that is spread across many data sources create a significant barrier if an organization wishes to perform predictive modeling using such data. For example, the bank analyzing the customer data may have some of its data on local servers at its branches, other data at a central location, some data in cloud computers, etc. In order to analyze all the customer data, the bank may have to move large amounts of data from one data storage location to another, which can be very difficult. Additionally, the organization may have constraints, including regulatory concerns, which preclude the movement of data. For example, a bank may not be able to access certain personal data about its clients given regulations related to privacy. As a result, many organizations simply do not use all of their data in creating predictive models, or they avoid predictive modeling altogether. Even when all data is used by an organization for generating predictive models, the organization may not be able to access the data in real time, resulting in less than full utilization of the predictive power of the predictive models.

A method and system disclosed herein, for analyzing data based on multiple disparate datasets, generates a unified predictive model based on a unified dataset, wherein the unified dataset includes data from the multiple disparate datasets. The unified predictive model is partitioned into a number of partial predictive models. The number of partial predictions are generated by applying each of the partial predictive models to data from each of the plurality of datasets and the plurality of partial predictions are combined to generate a unified prediction.

FIG. 1 illustrates an example block diagram of a data analysis system 100 disclosed herein. Specifically, the data analysis system 100 allows a bank 102 to use various data to generate various predictive outcomes. The example data analysis system 100 allows the bank 102 to generate predictive outcomes regarding a customer 104. In the illustrated implementation some of the data used by the bank includes the bank's proprietary data, wherein the data is saved in a bank database 108. For example, the bank database 108 stores data in a cloud-based server and in an analytic dataset (ADS) format. An example ADS may be in the form of a large de-normalized table that is used for predictive modeling. The ADS may be created based on normalized data. Furthermore, the ADS may be created on a temporary basis, as needed, and destroyed when its use is not necessary. In one implementation, the bank database 108 may be used to store both the data that is used to generate the ADS on a permanent basis as well as the ADS on a temporary basis.

The bank database 108 may store data about a customer's income range (x1), the customer's marital status (x2), etc. The data analysis system 100 is also illustrated to use a customer service representative (CSR) organization 106 and the data from the CSR organization 106 to generate predictive outcomes. The CSR organization 106 may be affiliated with the bank 102 or it may be external to the bank 102. The CSR organization 106 stores data in its own CSR database 110. The CSR database 110 may store data about the customer's gender (x3), the customer's age (x4), etc.

In view of various legal restrictions, the bank 102 may not be able to share some of the data from the bank database 108 with the CSR organization 106. Furthermore, if the CSR organization 106 is a third party organization providing services to the bank 102, the CSR organization 106 may not be willing to share the data from the CSR database 110 with the bank 102. Yet alternatively, even if the bank 102 and the CSR organization 106 are willing to share data with each other, due to the differences in storage format, location, etc., of the bank database 108 and the CSR database 110, sharing the data may be difficult or inefficient.

The data analysis system 100 allows the bank 102 and the CSR organization 106 to use predictive modeling using data from the bank database 108 and the CSR database 110. Specifically, the data analysis system 100 provides a model trainer module 120 that is used to analyze samples of data from the databases 108 and 110. In one implementation, the model trainer module 120 combines the samples of data from each of the databases 108 and 110 into a joint ADS database 122. Thus, in the illustrated example, each of the data about individual customers, such as the customer's income range (x1), the customer's marital status (x2), the customer's gender (x3), the customer's age (x4), etc., are collected and stored in the joint ADS 122. In one implementation, the model trainer 120 collects only a limited number of data points or records in the joint ADS database 122. For example, each of the bank database 108 and the CSR database 110 may have many thousands of customer records. However, only a small portion, say a few hundred records from each of these databases 108 and 110, is collected into the joint ADS database 122. Such datasets can be generated either by using random sampling, stratified sampling, etc.

The model trainer 120 combines the data samples from the databases 108 and 110 into a unified ADS set that is saved in the joint ADS database 122. In creating a unified ADS, the model trainer takes into account various relationships between the data from the bank database 108 and the CSR database 110. For example, if customer records from each of the bank database 108 and the CSR database 110 includes a common and unique field, for example the social security number of the customer, such a common field may be used as a key for generating the unified ADS. On the other hand, if customer records from the bank database 108 and the CSR database 110 includes a common but non-unique field, such as the zip code of the customer, the model trainer 120 either removes the field from one of the records or uses other methods to account for the duplication. The processing of the data from the different data fields ensures that there is no incorrect attribution effect to the duplicate fields.

Furthermore, the model trainer 120 also accounts for various correlations between the data from the databases 108 and 110. For example, if the bank database 108 has a field that specifies the occupation of a customer and the CSR database 110 includes a field specifying the income level of the customer, any correlation between such customer fields is taken into account by the model trainer. The processing based on the correlation of various fields allows generating the joint ADS where the relationships and/or correlations between various independent variables, which would be harmful to a predictive model if undetected, are found and accounted for. While the implementation of FIG. 1 illustrates the model trainer 120 performing one or more data unifying operations discussed above, in an alternative implementation, another module, such as a module residing on the joint ADS database 122, may be configured to perform the data selection and unification functions.

The model trainer 120 is also configured to generate a unified predictive model 124 based on the joint ADS. The unified predictive model 120 may be in the form of a linear or a non-linear regression, parametric or non parametric regression, a binomial logistic regression model, a multinomial logistic regression, polynomial regression, ridge regression, robust regression, Bayesian regression, a piecewise linear model, a neural networks model, etc. In the implementation illustrated in FIG. 1, the unified predictive model 124 is in the form of a regression model, where the score or value of the dependent variable y is a function of a number of independent variables x1 to x4. The dependent variable y may be, for example, the likelihood of a customer purchasing a retirement product. Thus, the score of the dependent variable may be in the form of percentages, with a higher percentage value indicating higher likelihood of the customer purchasing a retirement product. In one implementation, the unified predictive model 124 may be developed so as to optimally maximize the explanation power of the independent variables x1 to x4 on the dependent variable y. Alternatively, the unified predictive model 124 may be developed so that after the unified predictive model 124 is divided into a number of partial predictive models, the explanation power of the combined score resulting from the partial predictive models is maximized.

In one implementation, the model trainer 120 is configured to generate a predictive model that is decomposable into multiple independent parts. For example, the unified predictive model 124 is separable into a set of partial models, where each of the partial models is able to generate a partial score for the dependent variable that can be combined to generate the combined score for the dependent variable. Specifically, the unified predictive model 124 is divided into the partial predictive models so that all independent variables of each partial predictive model are residing in a separate database or in a separate category of databases.

The unified predictive model 124 may be separated into partial predictive models based on the access restrictions on the dependent variables so that a group of dependent variables with similar access restrictions are combined into one partial predictive model. Alternatively, the unified predictive model 124 may be separated into partial predictive models based on the geographic location of the databases containing the dependent variables. As a result. a group of dependent variables within a geographic location are combined into one partial predictive model. Yet alternatively, the unified predictive model 124 may be separated into partial predictive models based on the timing of the change in the value of the dependent variables so that a group of dependent variables that change in real time are separated from the group of variables that are more static. Alternatively, other criteria may be used to divide the unified predictive model 124 into separate partial predictive models.

For the example illustrated in FIG. 1, the unified predictive model 124 is separated into a partial predictive model A 126 and a partial predictive model B 128 based on the databases of the respective dependent variables for the partial predictive models 126 and 128. Specifically, the partial predictive model A 126 generates partial score for the dependent variable yₐ as a function of dependent variables x₁ and x₂, where the values of the variables x₁ and x₂ reside on the bank database 108. The value of the partial score yₐ may represent the contribution of the dependent variables x₁ and x₂ to the unified score y. Thus, given that x₁ represents the customer's income range and x₂ represents the customer's marital status, the partial predictive score yₐ may represent the likelihood of the customer buying a retirement product given the customer's income range and the customer's marital status.

The score for the dependent variable yₐ of the partial predictive model A 126 may be evaluated using the data from the bank database 108. The division of the unified predictive model 124 into the partial predictive models 126 and 128 allows that the data from the bank database 108 does not have to be moved outside of the bank database 108. Thus, only the score of the dependent variable yₐ of the partial predictive model A 126 is used outside of the bank database 108.

On the other hand, the partial predictive model B 128 generates partial score for the dependent variable y_{b} as a function of dependent variables x₃ and x₄, where the values of the variables x₃ and x₄ reside on the CSR database 110. The value of the partial score y_{b} may represent the contribution of the dependent variables x₃ and x₄ to the unified score y. Thus, given that x₃ represents the customer's gender and x₄ represents the customer's age, the partial predictive score y_{b} may represent the likelihood of the customer buying a retirement product given the customer's gender and the customer's age.

The scores of the dependent variables from each of the partial predictive models 126 and 128 are combined to generate a combined score 130. Given that the values of all of the dependent variables of the partial predictive model B 128 resides on the CSR database 110, the partial predictive model 128 may be evaluated using the data from the CSR database 110. In one implementation, the partial predictive models 126 and 128 are generated in a manner so that the combined score y_{f} substantially represents the score y generated by the unified prediction model 124.

The data analysis system 100 allows an organization to more flexibly generate predictive values to make decisions. In the illustrated example, the bank 102 is allowed to use the information about its customers including income level, etc., only if any confidential information about the customer is not shared with the CSR 106. While each of the partial predictive models 126 and 128 in the illustrated implementation are regression models, in an alternative implementation they may be different from each other. Thus, for example, the partial predictive model A 126 may be a neural network model and the partial predictive model B 128 may be a piecewise linear model, etc. Furthermore, while the illustrated implementation of the data analysis system 100 has only two partial predictive models, a different number of partial predictive models may be provided.

Similarly, while in the illustrated implementation of the data analysis system 100, the partial predictive models 126 and 128 are generated so that each of the partial predictive models 126 and 128 accesses a single database, in an alternative implementation each of the partial predictive models 126 and 128 may be configured to access more than one databases. For example, the partial predictive models 126 and 128 may be generated such that the partial predictive model A 126 accesses various databases within a particular state, while the partial predictive model B 128 accesses various databases outside the particular state.

An implementation of the data analysis system 100 allows a CSR working with the CSR organization 106 to make real time decisions in response to queries from customers. For example, the data analysis system may be implemented such that the scores of the partial predictions yₐ made by the partial predictive model A 126 are stored in a manner that they are accessible to the CSR organization 106. In this case, when the CSR receives an inquiry from the customer 104, the CSR may use the score of the partial prediction yₐ related to the customer 104, generate the score of the partial prediction y_{b} related to the customer 104 in real time, and combine the scores yₐ and y_{b} to generate the combined score y_{f} in real time. In this implementation, the CSR organization 106 is able to generate a better predictive score in a more efficient manner than an organization that relies on generating prediction using a prediction model that requires access to all databases storing the relevant data.

FIG. 2 illustrates an example block diagram 200 representing various modules of the data analysis system disclosed herein. Specifically, FIG. 2 illustrates databases 202, 204, and 206 storing various data that is used for predictive modeling. Specifically, the databases 202, 204, 206 store various analytical datasets (ADS's) that are used for predictive modeling. The ADS's from each of these databases are combined to form a main ADS that is stored in a database 208. In one implementation, all records from each of the databases 202, 204, 206 are combined into the main ADS. In an alternative implementation, only selected records are combined and stored into the main ADS. A model trainer 210 uses the main ADS from the database 208 to generate a unified predictive model 212.

In the illustrated implementation, the database 202 includes customer records with independent variable x₁, the database 204 includes customer records with independent variables x₁ and x₂, and the database 206 includes customer records with independent variables x₃, x₄, and x₅. In one implementation, the main ADS is generated such that the duplication of the variable x₃ is removed. This allows the resulting unified predictive model 212 to have higher predictive power for the dependent variable y. Furthermore, the main ADS is generated in such a manner that only those variables that have impact on the score of the dependent variable y are retained in the main ADS. Thus, for example, even when records in the database 206 include a variable x₅, when x₅ does not add to the explanation of the dependent variable y, it is not included in the main ADS.

FIG. 3 illustrates an alternative example block diagram 300 representing various modules of the data analysis system disclosed herein. Specifically, FIG. 3 illustrates the implementation a unified predictive model 302 that is used to generate a number of partial predictive models 310, 312, 314. A model trainer using a unified ADS may generate the unified predictive model 302. In the illustrated implementation, the unified predictive model 302 generates the score y based on values of independent variables x₁ to x₄.

In one implementation, the variables of each of the partial predictive models 310, 312, 314 are separated according to the data sources they originally came from. Thus, if the variable x₁ came from a database 320, the partial predictive model 310 generates a partial predictive score y₁ based on the value of the variable x₁. Alternatively, if the variable x₂ came from more than one data source, namely databases 322 and 324, the partial predictive model 310 generates a partial predictive score y₂ based on the value of the variable x₂. Similarly, if the variables x₃ and x₄ came from a database 326, the partial predictive model 314 generates a partial predictive score y₃ based on the value of the variables x₃ and x₄. In one implementation, one or more of the partial predictive models 310, 312, 314 are evaluated in a separate manner. Thus, for example, the partial predictive models 310 and 312 may be evaluated once at a predetermined time interval, for example every night. On the other hand, the partial predictive model 314 may be evaluated in real time based on the current data.

FIG. 4 illustrates an example of a graph 400 illustrating breakdown of various variables according to the data analysis system disclosed herein. Specifically, the graph 400 illustrates contribution of various dependent variables to the model. The x-axis of the graph 400 represents the contribution of the various variables to the model and the y-axis lists the variables, namely x₁ to x₅. For example, the variables x₁ to x₅ may respectively represent the gender, age, state, marital status, income range, and homeownership status of a customer of a bank. The variables x₁ to x₅ may be used to generate a predictive score of whether a customer will buy a retirement product. Thus, as illustrated, the age of the customer x₁ contributes more than any other of the variables x₂ to x₅ in predicting whether the customer will buy a retirement product whereas the homeownership status contributes the least.

In one implementation, the data 402 related to the variables x₁ to x₃ comes from a CSR organization database whereas the data 404 related to the variables x₄ to x₅ comes from a bank database. In this implementation, a first partial predictive model may be used to generate a first partial score using the data 402 related to the variables x₁ to x₃ from the CSR organization database and a second partial predictive model may be used to generate a second partial score using the data 404 related to the variables x₄ to x₅ from the bank database. As seen from the graph 400, as the data 402 coming from the CSR organization database contributes substantially more to the explanation power of the model, it may be useful to evaluate the first partial predictive model to generate the first partial score more frequently than evaluating the second partial predictive model to generate the second partial score. As a result, an implementation of the data analysis system disclosed herein evaluates the first partial predictive model in real time based on current data, whereas the second partial predictive model is evaluated on a periodic basis. The second partial score resulting of the periodic evaluation of the second predictive model may be communicated to the CSR organization database on a periodic basis. As a result, in real time, the data analysis system has to access only the CSR organization database.

FIG. 5 illustrates an alternative example block diagram 500 representing various modules of the data analysis system disclosed herein. Specifically, FIG. 5 illustrates a partial predictive model A 502 and a partial predictive model B 504. The partial predictive model A 502 generates a partial predictive score yₐ and the partial predictive model B 504 generates a partial predictive score y_{b}. In one implementation, each of the partial predictive models 502 and 504 may be different. Thus, for example, the partial predictive model A 502 is a linear model that generate the partial predictive score yₐ as a linear function of the independent variables x1 and x₂, the partial predictive model B 504 is a piecewise linear model, where the partial predictive score y_{b} is a sum of separate functions fᵢ and fᵢᵢ.

The partial predictive model A 502 is evaluated using data from a database 512 that generates an ADS with values for x₁ and x₂ whereas the partial predictive model B 504 is evaluated using data from a database 514 that generates an ADS with values for x₃ and x₄. The partial predictive scores yₐ and y_{b} are combined to generate the final predictive score y_{f} 516.

FIG. 6 illustrates another alternative example block diagram 600 representing various modules of the data analysis system disclosed herein. Specifically, FIG. 6 illustrates partial predictive models 602 and 604 using data from databases 612 and 614 respectively to generate partial predictive scores yₐ and y_{b}. In the illustrated implementation, the partial predictive score yₐ is generated on a periodic basis and communicated 616 to the database 614. Thus, for example, the partial predictive score yₐ may be calculated on a daily basis and communicated 616 to the database 614 every day. On the other hand, the predictive score y_{b} is calculated in real time. When it is required to generate the final predictive score 630 y_{f}, the previously calculated partial predictive score yₐ is communicated 622 from the database 614 to generate the final predictive score 630 y_{f}, whereas the predictive score y_{b} is calculated in real time and communicated 624 to generate the final predictive score 630 y_{f}.

FIG. 7 illustrates an example flowchart 700 for using the data analysis system disclosed herein. In one implementation, one or more operations of the flowchart 700 are implemented on a single computer. Alternatively, some of the operations are implemented on one computer or server whereas other operations are implemented on a separate computer or server. Specifically, the operations of the flowchart 700 are used to generate a final predictive score using various partial predictive models.

A receiving operation 702 receives data from various analytical datasets (ADS's). For example, the operation 702 receives customer data from a bank database and a CSR organization database. In one implementation, entire datasets are received and stored at a unified database. However in an alternative implementation only a section of the datasets is received, whereas the received sections are representative of data in the ADS's. An analyzing operation 704 analyzes the data received from the ADS's. The analysis may include, for example, analyzing the data for duplication, correlations, outliers, etc.

Subsequently, a generating operation 706 generates a unified prediction model. The unified prediction model is configured to generate a score based on the values of various variables. In one implementation, the generating operation 706 generates a unified prediction model so that the unified prediction model can be separated into a number of partial predictive models. Another generating operation 708 generates various partial predictive models based on the unified predictive models. The partial predictive models are configured to generate partial predictive scores using values of less than all of the variables used in the unified prediction model.

A determining operation 710 determines if a prediction request is received. In response to the prediction request, a generating operation 712 generates partial predictive scores. The generating operation 710 may receive data from the databases storing the ADS's and apply the data to the partial predictive models to generate the partial predictive scores. A combining operation 714 combines the partial predictive scores to generate a final predictive score.

FIG. 8 illustrates an alternative example flowchart 800 for using the data analysis system disclosed herein. In one implementation, one or more operations of the flowchart 800 are implemented on a single computer. Alternatively, some of the operations are implemented on one computer or server whereas other operations are implemented on a separate computer or server. Specifically, the operations of the flowchart 800 are used to generate a final predictive score using various partial predictive models.

A receiving operation 802 receives data from various analytical datasets (ADS's). For example, the operation 802 receives customer data from a bank database and a CSR organization database. In one implementation, entire datasets are received and stored at a unified database. However in an alternative implementation only a section of the datasets is received, whereas the received sections are representative of data in the ADS's. An analyzing operation 804 analyzes the data received from the ADS's. The analysis may include, for example, analyzing the data for duplication, correlations, outliers, etc.

Subsequently, a generating operation 806 generates a unified prediction model. The unified prediction model is configured to generate a score based on the values of various variables. In one implementation, the generating operation 806 generates a unified prediction model such that the unified prediction model can be separated into a number of partial predictive models. Another generating operation 808 generates various partial predictive models based on the unified predictive models. The partial predictive models are configured to generate partial predictive scores using values of less than all of the variables used in the unified prediction model.

Subsequently, a determination operation 810 determines whether one or more of the partial predictive operations are evaluated periodically or in real time. For example, the determination operation 810 may make the determination based on the availability of data from various datasets, cost attached to real time access, the contribution of various variables to the predictive power of the final prediction, regulatory barriers to access data, etc. For example, if a partial predictive model uses variables that do not make significant contribution to the final prediction, the partial predictive model is evaluated on a periodic basis to reduce the time and cost of generating the final predictions. Subsequently, an evaluation operation 812 evaluates the partial predictive models that are designated as periodic partial predictive models. For example, the evaluation may be done on daily basis at a time of the day when it is easy and less disruptive to access data. A communication operation 814 communicates the partial predictive scores generated by the evaluation of the periodic partial predictive models to a location where one or more real time partial predictive models are evaluated. The partial predictive scores generated by the evaluation of the periodic partial predictive models are stored at such location for use in generating the final predictive scores.

A determining operation 816 determines if a prediction request is received. In response to the prediction request, a generating operation 818 generates real time partial predictive scores. The generating operation 818 may receive real time data from the databases storing the ADS's and apply the data to the real time partial predictive models to generate the real time partial predictive scores. A combining operation 820 combines the periodic partial predictive scores with the real time partial predictive scores to generate a final predictive score.

FIG. 9 illustrates an example computing system that can be used to implement one or more components of the data analysis system method and system described herein. A general-purpose computer system 900 is capable of executing a computer program product to execute a computer process for analyzing data using the partial prediction models. Data and program files may be input to the computer system 900, which reads the files and executes the programs therein. Some of the elements of a general-purpose computer system 900 are shown in FIG. 9, wherein a processor 902 is shown having an input/output (I/O) section 904, a Central Processing Unit (CPU) 906, and a memory section 908. There may be one or more processors 902, such that the processor 902 of the computer system 900 comprises a single central-processing unit 906, or a plurality of processing units, commonly referred to as a parallel processing environment. The computer system 900 may be a conventional computer, a distributed computer, or any other type of computer such as one or more external computers made available via a cloud computing architecture. The described technology is optionally implemented in software devices loaded in memory 908, stored on a configured DVD/CD-ROM 910 or storage unit 912, and/or communicated via a wired or wireless network link 914 on a carrier signal, thereby transforming the computer system 900 in FIG. 9 to a special purpose machine for implementing the described operations.

The I/O section 904 is connected to one or more user-interface devices (e.g., a keyboard 916 and a display unit 918), a disk storage unit 912, and a disk drive unit 920. Generally, in contemporary systems, the disk drive unit 920 is a DVD/CD-ROM drive unit capable of reading the DVD/CD-ROM medium 910, which typically contains programs and data 922. Computer program products containing mechanisms to effectuate the systems and methods in accordance with the described technology may reside in the memory section 904, on a disk storage unit 912, or on the DVD/CD-ROM medium 910 of such a system 900, or external storage devices made available via a cloud computing architecture with such computer program products including one or more database management products, web server products, application server products and/or other additional software components. Alternatively, a disk drive unit 920 may be replaced or supplemented by a floppy drive unit, a tape drive unit, or other storage medium drive unit. The network adapter 924 is capable of connecting the computer system to a network via the network link 914, through which the computer system can receive instructions and data embodied in a carrier wave. Examples of such systems include Intel systems offered by Apple Computer, Inc., personal computers offered by Dell Corporation and by other manufacturers of Intel-compatible personal computers, AMD-based computing systems and other systems running a Windows-based, UNIX-based, MAC OSₓ, or other operating system. It should be understood that computing systems may also embody devices such as Personal Digital Assistants (PDAs), mobile phones, smart-phones, gaming consoles, set top boxes, tablets or slates (e.g., iPads), etc.

When used in a LAN-networking environment, the computer system 900 is connected (by wired connection or wirelessly) to a local network through the network interface or adapter 924, which is one type of communications device. When used in a WAN-networking environment, the computer system 900 typically includes a modem, a network adapter, or any other type of communications device for establishing communications over the wide area network. In a networked environment, program modules depicted relative to the computer system 900 or portions thereof, may be stored in a remote memory storage device. It is appreciated that the network connections shown are exemplary and other means of and communications devices for establishing a communications link between the computers may be used.

Further, the plurality of internal and external databases, data stores, source database, and/or data cache on the cloud server are stored as memory 908 or other storage systems, such as disk storage unit 912 or DVD/CD-ROM medium 910 and/or other external storage device made available and accessed via a cloud computing architecture. Still further, the processor 902 may perform some or all of the operations for the data analysis system disclosed herein. In addition, one or more functionalities of the data analysis system disclosed herein may be generated by the processor 902 and a user may interact with these GUIs using one or more user-interface devices (e.g., a keyboard 916 and a display unit 918) with some of the data in use directly coming from third party websites and other online sources and data stores via methods including but not limited to web services calls and interfaces without explicit user input.

In the interest of clarity, not all of the routine functions of the implementations described herein are shown and described. It will, of course, be appreciated that in the development of any such actual implementation, numerous implementation-specific decisions must be made in order to achieve the developer's specific goals, such as compliance with application- and business-related constraints, and that those specific goals will vary from one implementation to another and from one developer to another.

According to one embodiment of the present invention, the components, process steps, and/or data structures disclosed herein may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, connections and networks, data stores, or a stand-alone device. The process can be implemented as instructions executed by such hardware, hardware alone, or any combination thereof. The software may be stored on a program storage device readable by a machine.

According to one embodiment of the present invention, the components, processes and/or data structures may be implemented using machine language, assembler, C or C++, Java and/or other high level language programs running on a data processing computer such as a personal computer, workstation computer, mainframe computer, or high performance server running an OS such as Solaris® available from Sun Microsystems, Inc. of Santa Clara, Calif., Windows Vista™, Windows NT®, Windows XP PRO, and Windows® 2000, available from Microsoft Corporation of Redmond, Wash., Apple OS X-based systems, available from Apple Inc. of Cupertino, Calif., or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet or other networks. Different implementations may be used and may include other types of operating systems, computing platforms, computer programs, firmware, computer languages and/or general purpose machines; and. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

In the context of the present invention, the term “processor” describes a physical computer (either stand-alone or distributed) or a virtual machine (either stand-alone or distributed) that processes or transforms data. The processor may be implemented in hardware, software, firmware, or a combination thereof.

In the context of the present technology, the term “data store” describes a hardware and/or software means or apparatus, either local or distributed, for storing digital or analog information or data. The term “Data store” describes, by way of example, any such devices as random access memory (RAM), read-only memory (ROM), dynamic random access memory (DRAM), static dynamic random access memory (SDRAM), Flash memory, hard drives, disk drives, floppy drives, tape drives, CD drives, DVD drives, magnetic tape devices (audio, visual, analog, digital, or a combination thereof), optical storage devices, electrically erasable programmable read-only memory (EEPROM), solid state memory devices and Universal Serial Bus (USB) storage devices, and the like. The term “Data store” also describes, by way of example, databases, file systems, record systems, object oriented databases, relational databases, SQL databases, audit trails and logs, program memory, cache and buffers, and the like.

The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understand that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A method, comprising:
generating a unified predictive model based on a unified dataset, wherein the unified dataset comprises data from a plurality of datasets; and
partitioning the unified predictive model into a plurality of partial predictive models, wherein each of the plurality of partial predictive models can be evaluated using data from a separate one of the plurality of datasets.

2. The method of claim 1, further comprising:
generating a plurality of partial predictions by evaluating one or more of the plurality of partial predictive models using data from one or more of the plurality of datasets; and
combining the plurality of partial predictions to generate a unified prediction.

3. The method of claim 2, wherein the plurality of datasets reside at different locations.

4. The method of claim 2, wherein the plurality of datasets are located on different servers.

5. The method of claim 2, wherein generating the unified predictive model further comprises combining data from the plurality of datasets in a manner so as to substantially remove the duplication of contribution by one or more related variables to the unified prediction.

6. The method of claim 2, wherein partitioning the unified predictive model further comprises partitioning the unified predictive model based on explanation power of the unified prediction for a prediction generated by the unified prediction model.

7. The method of claim 2, wherein partitioning the unified predictive model further comprises partitioning the unified predictive model based on at least one of (1) access restriction to one or more of the plurality of datasets; (2) geographic locations of the one or more of the plurality of datasets; and (3) cost of access to the one or more of the plurality of datasets.

8. The method of claim 2, wherein partitioning the unified predictive model further comprises partitioning the unified predictive model based on the expected timing of change in the values of the one or more datasets.

9. The method of claim 2, wherein partitioning the unified predictive model further comprises partitioning the unified predictive model into one or more real time partial predictive models and one or more periodic partial predictive models, wherein the one or more real time partial predictive models are evaluated substantially in real time and the one or more periodic partial predictive models are evaluated on a periodic basis.

10. The method of claim 9, wherein generating the plurality of partial predictions further comprising:
generating one or more periodic partial predictions by evaluating the one or more periodic partial predictive models; and
communicating the one or more periodic partial predictions to a real time partial predictive models evaluation module.

11. The method of claim 10, further comprising:
generating one or more real time partial predictions at the real time partial predictive models evaluation module; and
combining the one or more periodic partial predictions with the one or more real time partial predictions.

12. One or more tangible computer-readable storage media storing computer executable instructions for performing a computer process on a computing system, the computer process comprising:
generating a unified predictive model based on a unified dataset, wherein the unified dataset comprises data from a plurality of datasets;
partitioning the unified predictive model into a plurality of partial predictive models;
generating a plurality of partial predictions by evaluating one or more of the plurality of partial predictive models using data from one or more of the plurality of datasets; and
combining the plurality of partial predictions to generate a unified prediction.

13. The one or more tangible computer-readable storage media of claim 12, wherein the plurality of datasets (1) reside at different locations or (2) are located on different servers.

14. The one or more tangible computer-readable storage media of claim 12, wherein partitioning the unified predictive model further comprises partitioning the unified predictive model based on at least one of (1) access restriction to one or more of the plurality of datasets; (2) geographic locations of the one or more of the plurality of datasets; and (3) cost of access to the one or more of the plurality of datasets.

15. The one or more tangible computer-readable storage media of claim 12, wherein partitioning the unified predictive model further comprises partitioning the unified predictive model into one or more real time partial predictive models and one or more periodic partial predictive models, wherein the one or more real time partial predictive models are evaluated substantially in real time and the one or more periodic partial predictive models are evaluated on a periodic basis.

16. The one or more tangible computer-readable storage media of claim 15, wherein the computer process for generating the plurality of partial predictions further comprising:
generating one or more periodic partial predictions by evaluating the one or more periodic partial predictive models; and
communicating the one or more periodic partial predictions to a real time partial predictive models evaluation module.

17. A system, comprising:
a computer readable memory module configured to store a unified analytical dataset (ADS), wherein the unified ADS comprises data from a plurality of datasets;
a model trainer module configured to generate a unified predictive model based on a unified ADS; and
a partition module configured to partition the unified predictive model into a plurality of partial predictive models, wherein each of the plurality of partial predictive models can be evaluated using data from one of the plurality of datasets.

18. The system of claim 17, further comprising a plurality of partial prediction modules configured to generate a plurality of partial predictions by evaluating one or more of the plurality of partial predictive models using data from one or more of the plurality of datasets.

19. The system of claim 18, further comprising a combination module configured to combine the plurality of partial predictions to generate a unified prediction.

20. The system of claim 18, wherein the plurality of partial prediction modules are located at one of (1) different servers and (2) different locations.
